(19) United States
(12) Patent Application Publication
(10) Pub. No.: US 2009/0220295 A1
(43) Pub. Date: Sep. 3, 2009

(54) CONNECTOR DEVICE

(76) Inventor: John Carney, Slaughters Rough (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/573,492

(22) PCT Filed: Mar. 31, 2005
(86) PCT No.: PCT/GB2005/001271

§ 371 Date: Aug. 12, 2008

(30) Foreign Application Priority Data
Aug. 12, 2004 (GB) 0418027.9

(51) Int. Cl. E04F 11/18; F16D 1/12

(52) U.S. Cl. 403/91

(57) ABSTRACT

A connector device for interconnecting two members, the device including a first body portion (5) arranged for abutment with a surface of one of the two members, a second body portion (14) moveably attached to the first body portion. The device has attachment means (7) for attachment thereof to the other of the two members, and locking means including a locking member (6) arranged to be secured, by action of said abutment with said surface, into a locking position of engagement with the second body portion such that movement of the second body portion relative to the first body portion is restrained by the engaged clocking member.

The present invention relates to connector devices for interconnecting two members. In particular, though not exclusively, the present invention relates to connector devices for interconnecting two members of a rail (e.g. stair rail) apparatus.

The assembly of a stair rail apparatus typically involves the connection of a hand or foot rail to vertically extending posts, such as baluster posts which interconnect hand and foot rails. The inclination of the assembled stair rail apparatus determines the angle at which the hand/foot rail and vertical posts meet at their point of connection. Of course, the inclination of the stair rail apparatus will vary from one assembly to another, and so too will the rail-post connection angle. A connector device suitable for providing such a rail-post connection must therefore be capable of accommodating a range of connection angles if it is to be versatile.

Existing connector devices for stair rail assemblies typically employ two pivotably connected body portions, one arranged to attach to a rail and the other arranged to attach to a post. Pivoting of one body portion relative to the other allows an appropriate connection angle to be adopted as between the body portions of the connector device and, therefore, as between the assembly members interconnected thereby. However, securing the adopted relative angular position of the two body portions of the connector advantageously requires some means for fixing or locking the body portions in that position. Locking bolts or screws are usually employed to this end but must be placed in the locking position (e.g. tightened) after one body portion has been attached to, for example, the stair rail and the other portion positioned in the desired orientation. This positioning and locking operation complicates the assembly process.

The present invention aims to provide a simple and versatile connector device which permits a simplified assembly process when connecting two members, e.g. of a stair rail assembly. At its most general, the present invention proposes a connector device having two relatively moveable body portions and having a locking means which is caused to lock the two body portions in a desired relative position by the act of connecting or simply abutting one body part to one of the two (or more) members to be interconnected by the device. In this way the connecting of one body portion to one of the two members to be interconnected, and the fixing of the orientation of the two body portions of the connector device, may be achieved simultaneously in the same single act or action. This greatly simplifies the assembly process.

Thus, a first of its aspects, the present invention may provide a connector device for interconnecting two members, the device including a first body portion arranged for abutment with a surface of one of the two members, a second body portion moveably attached/connected to the first body portion and having attachment means for attachment thereof to the other of the two members, and locking means including a locking member arranged (e.g. on/in the first body portion) to be secured, by action of the abutment with the aforesaid surface of one of the two members, into a locking position of engagement with the second body portion such that movement of the second body portion relative to the first body portion is restrained by the engaged locking member. In this way, the act of abutment maintains the first and second body portions in a substantially secured relative position/orientation.

The locking means may be arranged to move (e.g. towards the second body portion), be placed or be positioned by action of said abutment into said locking position so as to restrain further relative movement between the first and second body portions in use. The action of said abutment may secure the locking means in said locking position by preventing its subsequent movement out of a locking position, with or without relative movement between the locking means and other relevant parts of the device.

The action of abutment may move the locking member relative to the second body portion but without moving the locking member relative to the first body portion, or relative to both the first and second body portions. For example, the locking member may be a substantially immoveable (e.g. rigidly attached to) part of the first body portion such that the aforesaid abutment (and the associated movement during abutment) of the first body portion moves the locking member relative to the second body portion, but not relative to the first body portion, into the locking position. Thus, a movement of the locking member (and the first body portion as a whole) would also occur, during the abutment process, relative to the surface being abutted to. The second body portion may be held immobile relative to the abutted surface during the act of abutment.

Thus, the connector device is structured such that the physical act of abutting the first body portion to the surface of one of the two members causes the locking of the second body portion relative to the first body portion in whatever orientation the former has adopted when abutment takes place. Additional locking screws/bolts dedicated to the function of locking first and. second body portions are not required. The locking member may be connected to or formed with the first body portion, or may be unconnected to but moveably housed within the first body portion (e.g. a peg/key physically separate from the first body portion).

A part of the second body portion may be secured between the first body portion and said surface by action of said abutment thereby to secure said locking member into a locking position. The locking member is preferably a part of the first body portion and arranged to be secured against an opposing part of the second body portion in said locking position by action of abutment of said first body portion with said surface. The second body portion is preferably arranged to abut said surface by action of the abutment of the first body portion with said surface thereby to permit simultaneous abutment of said first and said second body portions with said surface. A part of the second body portion may be arranged to abut said surface, and to be moveable (relative to the first body portion) from a position of outward protrusion beyond the first body portion when the first body portion is not abutted with said surface, to a position of flush adjacency with abutting parts of the first body portion by action of the abutment of the first body portion with said surface.

For example, the locking member may comprise a part of the first body portion structured and arranged to be secured (e.g. urged or pressed) against or adjacent an opposing part of the second body portion into the locking position by action of said abutment. The second body portion may be structured and arranged to abut a part of the one of the two members against which the first body portion is also arranged to be abutted in use. For example, the action of simultaneous abutment of the first and second body portions against the aforesaid one of the two members preferably secures the locking member in the locking position. This may be done simply by causing the aforesaid one of the two members to prevent the locking member from moving out of a locking position. Additionally the abutment of the first body member against the aforesaid one of the two members may push part of the second body portion into abutment with the member, which may result in a reactive force from the member against the second body portion which presses the second body portion against the first body portion into a locking position. Thus, in use, a part of the second body portion may be sandwiched by and between parts of the first body portion and the member against which both body portions are abutted. This sandwiching may press and/or constrain the locking member into a locking position.

The second body portion may be moveably connected/attached to the first body portion such that parts of the second body portion which are arranged to be abutted against the aforesaid one of the two members in use are arranged to be flush with adjacent parts of the first body portion which are also arranged for such abutment. Subsequent simultaneous abutment of the first and second body portions against the aforesaid same member may simply result in the constraining/trapping of the locking member in a locking position. Alternatively, or additionally, parts of the second body portion which are arranged to be abutted against the aforesaid one of the two members in use may be arranged to project a relatively small amount (e.g. a few millimetres, or a fraction of a millimetre) outwardly of the body of the connector device beyond adjacent parts of the first body portion which are also arranged for such abutment. The parts of the second, and the adjacent parts of the first, body portions are preferably arranged to be substantially flush with each other in use when the locking member is in the locking position.

In this way, prior to abutment, flush adjacency or a small amount of outward projection from the connector device of parts of the second body portion beyond adjacent parts of the first body portion, ensures that abutting the first body portion to one of the two members in use also causes the second body portion not only to be so abutted, but also to be secured in place by being e.g. pushed, pressed or urged towards parts of the first body portion and into a locking position.

One or more projections or lugs (e.g. teeth) may be formed with, or connected to, the second body portion and arranged to engage opposing parts of the first body portion by action of said abutment of the first body portion (or vice versa). The opposing parts of the first body portion may comprise one or more teeth arranged for the purposes of engaging opposing parts of the second body portion in use. Thus a ratchet-like arrangement may be provided.

The engagement may be active (i.e. involving an active force) or may be passive (e.g. involving only the bringing together/interlocking of parts without forced contact or interface therebetween).

The locking member may be arranged for abutment with the aforesaid surface of a member, and may be moveable (i.e. towards the second body portion) by action of that abutment. The locking member may be so moveable from a position of outward projection from the first body portion when not abutted with the surface, to the locking position when so abutted. Thus, the extend of outward projection from the first body portion may determine the extent to which the locking member is moved (e.g. towards the second body portion) by action of the aforesaid abutment. The locking member may be moveable towards the locking position, so as to no longer project outwardly of the first body portion when the locking position is reached if desired.

The connector device may be such that the first and second body portions are moveable relative to one another in any desired manner. Preferably the permitted relative movement is a pivoting type movement, but it may also be a sliding (e.g. linear) relative movement alternatively or in addition to the pivoting movement.

The connector device may include pivot means via which the second body portion is moveably attached/connected to the first body portion so as to be pivotably moveable relative thereto.

When in its locking position the locking member may engage passively with the second body portion such as, for example, a locking peg/key/wedge housed or arranged in the first body portion to move towards (by action of abutment) and engage with a corresponding lock joint/slot formed in the second body portion when in the locking position. Alternatively, or additionally, the locking member may actively engage the second body portion by applying force/friction thereto when in its position of engagement. The locking member is preferably arranged to press against the second body portion in its position of engagement with the second body portion.

The locking means may include one or more teeth via which the locking member and the second body portion engage each other when in the position of engagement. For example, the locking means may include one or more teeth arranged upon the second body portion and, in opposed relation thereto, one or more corresponding teeth arranged upon the locking member so as to provide a ratchet and a corresponding pawl respectively.

The locking member may be rigidly connected to, or formed in, the first body part. The first and second body parts are preferably freely moveable relative to each other in the absence of the action of abutment.

The locking member may be arranged to be biased away from the locking position, e.g. towards the aforesaid position of outward projection from the first body portion. In this arrangement only the act of abutment will cause the locking position to be assumed by the locking member, the locking member moving out of that locking position when abutment ceases.

For example, the locking means may include a limb portion of resiliently deformable material one end of which is attached to the first body portion and the other end of which is unattached thereto. The locking member is preferably positioned upon the limb portion beyond the one end thereof, e.g. at or adjacent the other end thereof, and is preferably moveable relative to the first body portion by flexure of the limb portion. Plastics, metals or other suitably resilient materials may be used to form the limb portion. Preferably, the limb portion, locking member and first body portion are integrally formed.

The first body portion preferably defines an (e.g. outwardly presented) abutment region shaped to reciprocally correspond with the shape of the surface with which it is arranged to be abutted. The locking member, when arranged to abut said surface, may have an (e.g. outwardly presented) abutment surface shaped to conform to the shape of the abutment region. When the second body portion is arranged to abut said surface, it may have an outwardly presented abutment surface shaped to conform to the shape of the abutment region. The abutment region and abutment surface may be curved, flat or any other shape as dictated by the surface to which they are to be abutted.

The locking member when not in said locking position (e.g. in the aforesaid position of outward projection) is preferably spaced or separable from the opposing parts of the second body portion, and may be so spaced or separable by a separation (e.g. by a substantially constant spacing) which is substantially independent of movement of the second body portion relative to the first body portion. This ensures that a constant degree of displacement is required of the locking member when moving into the locking position, irrespective of the orientation/position of the first body portion relative to the second.

For example, the second body portion may be shaped to present to the locking member a curved outer surface the radius of curvature of which is substantially constant and centred upon an axis about which the second body portion is pivotably moveable relative to the first body portion.

Preferably the first and second body portions are releasably connected (or connectable) together via the pivot means. More preferably, the first and second body portions are releasably interlocked (or interconnectable) via the pivot means. Parts of the first body portion may interlock with parts of the second body portion thereby to connect the two. The pivot means may include a collar member forming part of one of the first and second (e.g. the first) body portions and a corresponding axle member forming part of the other of the first and second body portions (e.g. the second) and shaped to be received (preferably intimately received) within the collar member.

The collar member may be formed by a shaping of the first body portion and the axle member may me provided by the second body portion. For example, the first body portion may be shaped to define an opened collar structure having a circumferential opening dimensioned to permit entry of the axle member for receipt thereof by an axle-seating structure (e.g. an archway structure having an incomplete circular boundary e.g. semi-circular) of the collar member in which the axle member may be seated.

The locking member may be a projection(s) (e.g. tooth/teeth) arranged to project from the axle-seating surface of the collar structure so as to engage with an axle structure received therein when in a locking position in use.

Alternatively, the collar member may be formed by a shaping of the second body portion and the axle member may be provided by the first body portion.

One or more lugs may be provided which extend from an inwardly facing (i.e. concave) surface of the collar (or an outwardly convex surface of the axle) member and are each received in a guide channel formed in the axle (or the collar) member. The lugs, so received, serve for retaining the axle member within the collar member and for guiding the pivotal movement of the second body portion relative to the first body portion.

Preferably, one or more access slots are formed within a wall of a guide channel and each such slot extends from a guide channel wall and the direction of along the axis of the axle (or the collar) member to an outermost end thereof. Most preferably each access slot is shaped to permit movement of a lug therealong thereby enabling placement/removal of the lug(s) within/from a respective guide channel when assembling/disassembling the connector device. This enables assembly/disassembly of the collar (or axle) member, to which the lugs are attached, onto/from the axle (or collar) member within which the access slots are formed. No connecting bolts/screws are required thereby simplifying assembly.

In preferred arrangements, the lug(s) are preferably arranged upon the collar member such that when the aforementioned one or more teeth upon the second body portion are provided in opposed relation to one or more aforesaid corresponding teeth arranged upon the locking member, the lug(s) within a guide channel are not aligned with respective access slots. In this way the collar member is securely interlocked with the axle member without use of attachment screws/bolts, and may be released therefrom by a simple turning (to align lugs with access slots) and pulling action (along the direction of the axle axis). The turning required for such release is beyond that to which the second body portion will be turned in use.

Preferably, the locking member interfaces with said second body portion to offer resistance to movement of the second body portion relative to the first body portion when the first body part is not abutted with the surface thereby to prevent free movement of the second body portion relative to the first without locking the two body portions. Where opposing ratchet and pawl teeth are employed in the locking means, the opposing sets of teeth preferably partially engage when the locking member is not in the locking position and are sufficiently separated to permit the pawl teeth to ride over the ratchet teeth as the second body portion moved relative to the first. For example, the collar member may be dimensioned relative to a received axle member to permit a limited degree free movement of the received axle member to and from the locking member. For example, this free movement may be permitted by the circumferential opening of an opened collar structure. This arrangement is advantageous when the collar member is provided by the first body portion. This free movement may be sufficient to permit the locking member to move into and out of the locking position prior to abutment, but is insufficient to permit this when the connector device is abutted to the surface of said one of the two members in use.

Alternatively, e.g. when the collar member is provided by the second body portion, flexure of a resiliently deformable limb portion of the locking means may facilitate this.

The connector device preferably includes fixing means for fixing the first body portion in abutment with the aforesaid surface of one of the two members such that the surface presses against the locking member thereby to press the locking member into the locking position. Fixing screws or nails/bolts and holes therefore in the first body portion, may be employed. Adhesives may be used.

The connector device may interconnect two members of a stair rail assembly. One member may be a shoe or hand rail of a stair rail assembly, and the other member may be a post (e.g. baluster) thereof.

In a second aspect, the present invention may provide a stair rail assembly including connector device according to the invention in its first aspect together with the two members.

The present invention may be sold as a kit of parts for assembly into a connector device, or into a stair rail assembly including such a device. In a third aspect, the present invention may provide a kit of parts for a providing, when assembled, a connector device according to the invention in its first aspect.

In a fourth aspect, the present invention may provide a kit of parts for a providing, when assembled, a stair rail assembly according to the invention is its second aspect.

In a fifth aspect, the present invention may provide a kit of parts for a connector device for interconnecting two members, the parts including a first body portion arranged for abutment with a surface of one of the two members, a second body portion arranged to be moveably connected to the first body portion and having attachment means for attachment thereof to the other of the two members, and locking means including a locking member arranged in the first body portion to be secured e.g. moved/positioned (e.g. towards the second body portion of the assembled device), by action of said abutment with said surface, into a locking position of engagement with the second body portion of the assembled device such that movement of the second body portion relative to the first body portion is restrained by the engaged locking member.

The locking member of the kit of parts may be arranged in the first body portion to move, by action of said abutment with said surface, into a locking position of engagement with the second body portion.

Non-limiting examples of the invention shall now be illustrated with reference to the accompanying drawings in which:

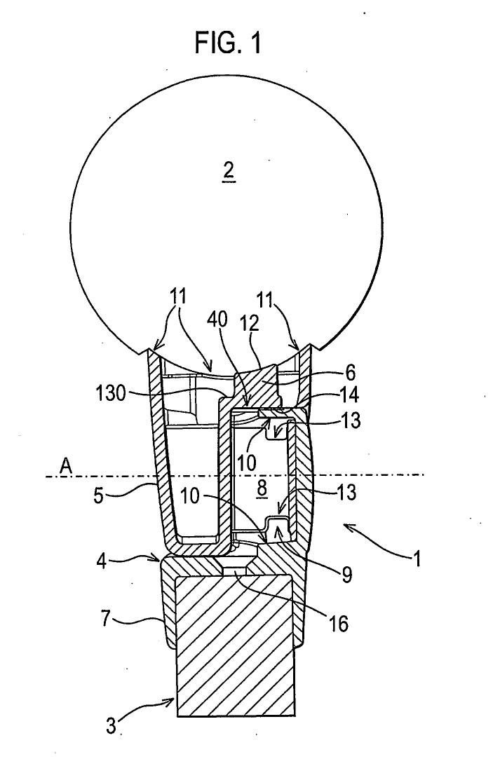

FIG. 1 illustrates a cross-sectional view of a connector device interconnecting a handrail member to a post member of a stair rail assembly;

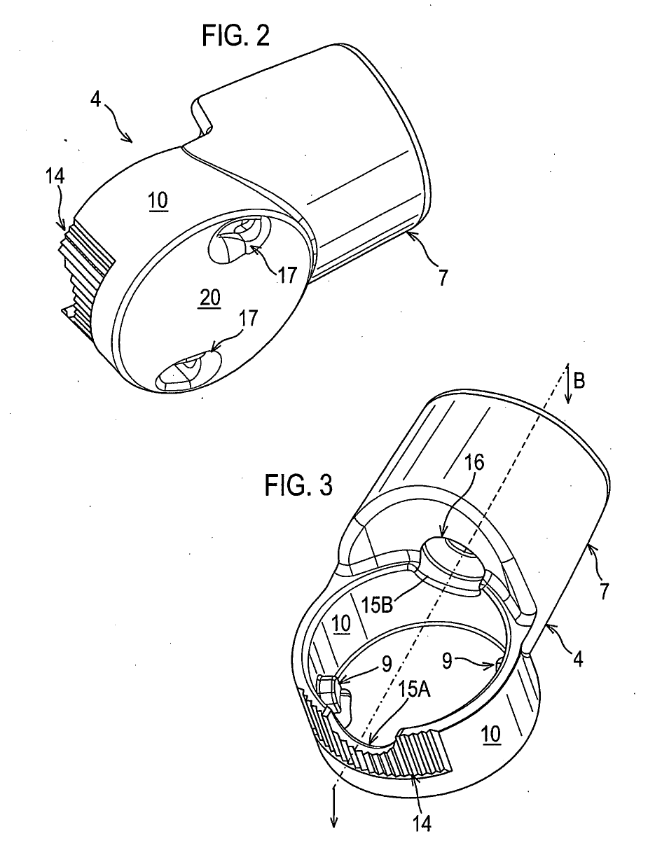

FIG. 2 illustrates an oblique view of one side of a second body portion of the connector device of FIG. 1;

FIG. 3 illustrates another oblique view of one end of the second body portion of the connector device of FIG. 1 and FIG. 2;

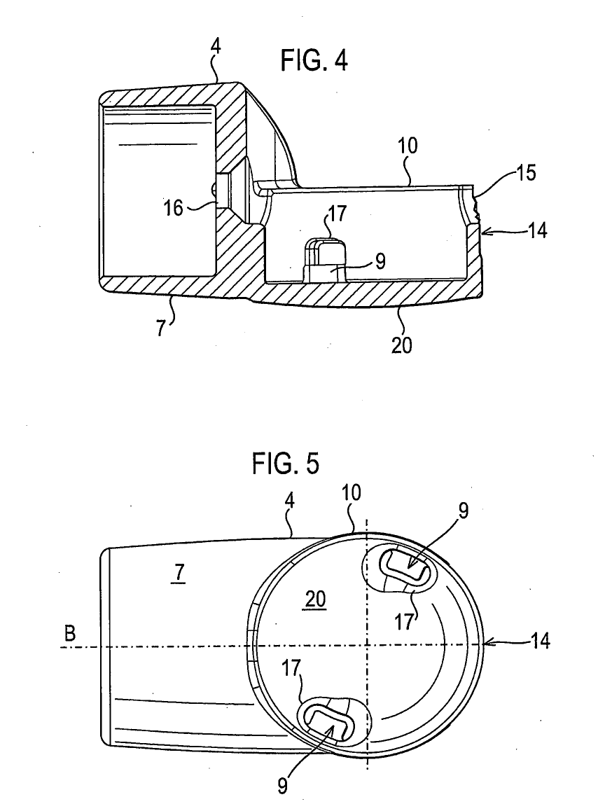

FIG. 4 illustrates a cross-sectional view across the longitudinal axis B of the second body portion of FIGS. 1 to 3;

FIG. 5 illustrates a plan view of the side of the second body portion obliquely viewed in FIG. 2;

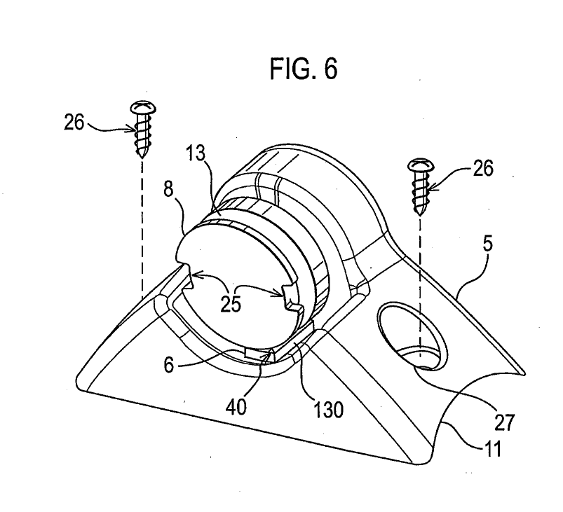

FIG. 6 illustrates an oblique view of one side of the first body portion of the connector device illustrated in FIG. 1, together with fixing means therefore;

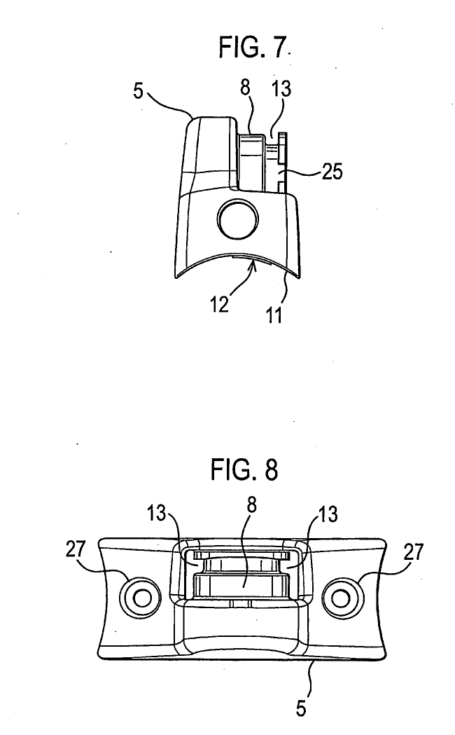

FIG. 7 illustrates a side view of the first body portion illustrated in FIG. 6;

FIG. 8 illustrates a plan view of the first body portion illustrated in FIGS. 6 and 7;

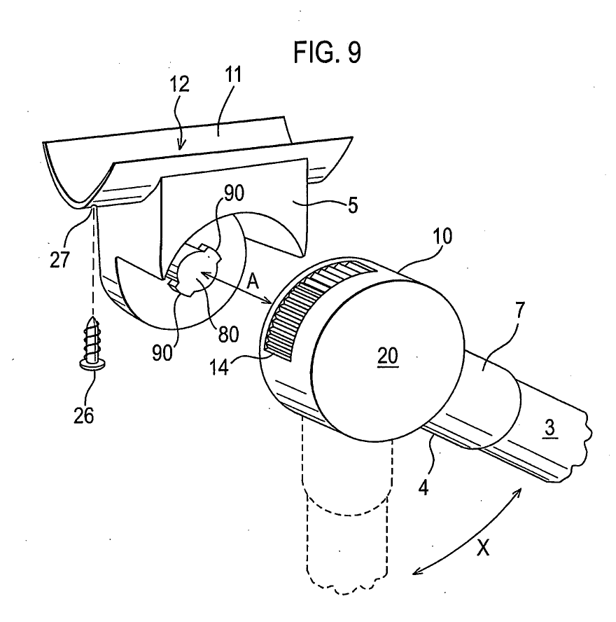

FIG. 9 illustrates an exploded view of the first and second body portions of a connector device according to another embodiment of the present invention;

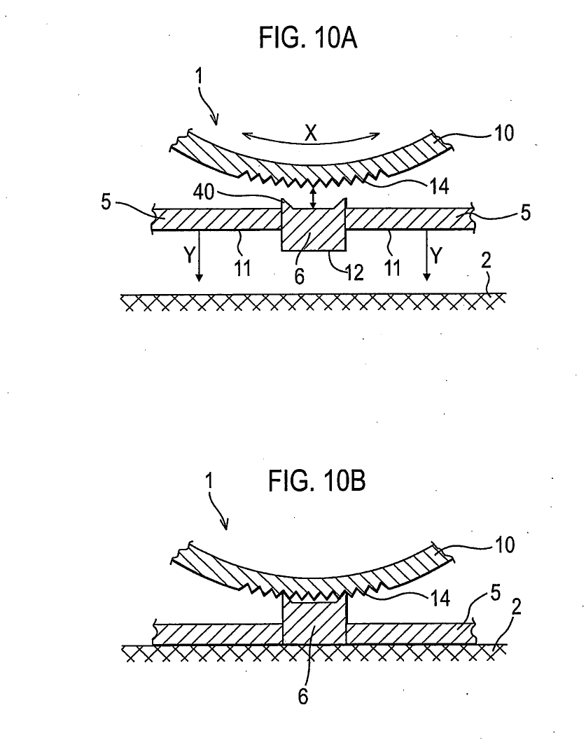

FIGS. 10A and 10B illustrate schematically the manner in which, by action of abutment with the surface of the hand rail portion 2, the first and second body portions of the connector devices of embodiments of FIGS. 1 to 8, and of FIG. 9, are locked together;

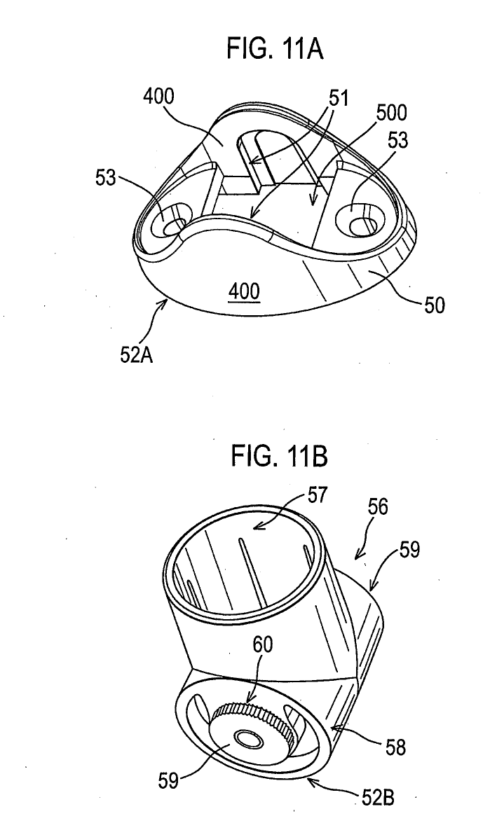

FIGS. 11A and 11B illustrate obliquely views of a first and second body portion, respectively, of a connector device;

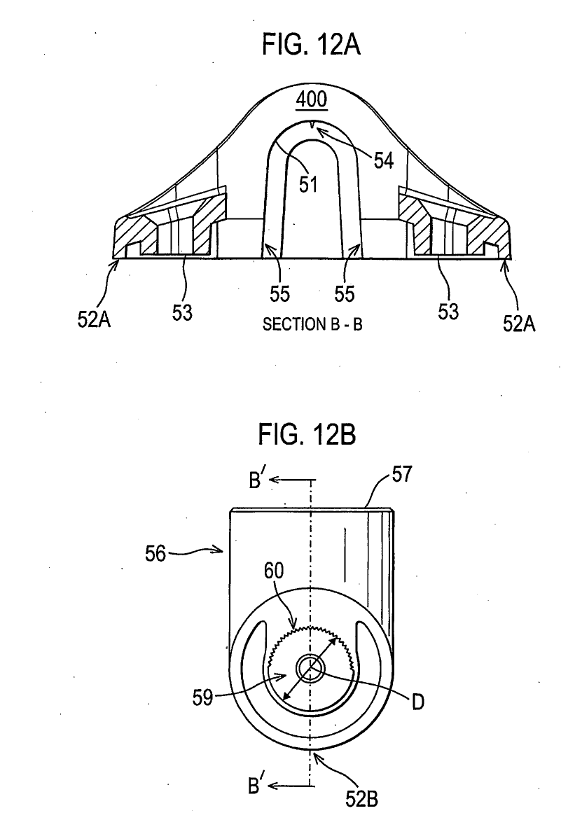

FIGS. 12A and 12B respectively illustrate a cross-sectional side view of the first body portion of FIG. 11A, and a side view of the second body portion of FIG. 11B;

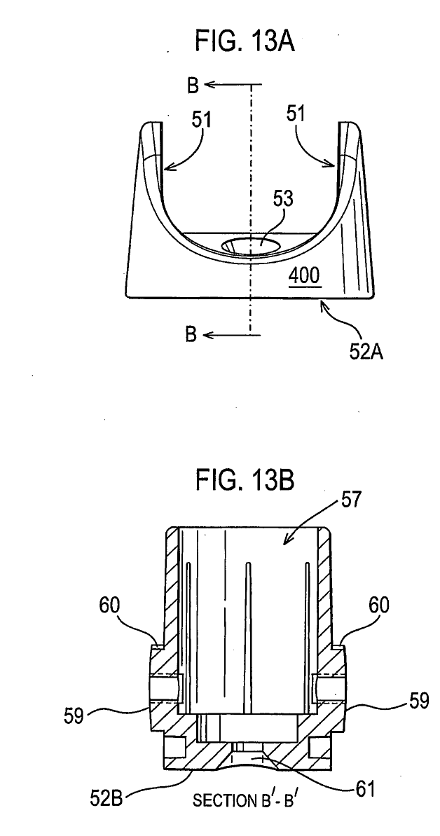

FIGS. 13A and 13B respectively illustrate an end view of the first body portion of FIG. 11A, and a cross-sectional side view of the second body portion of FIG. 11B;

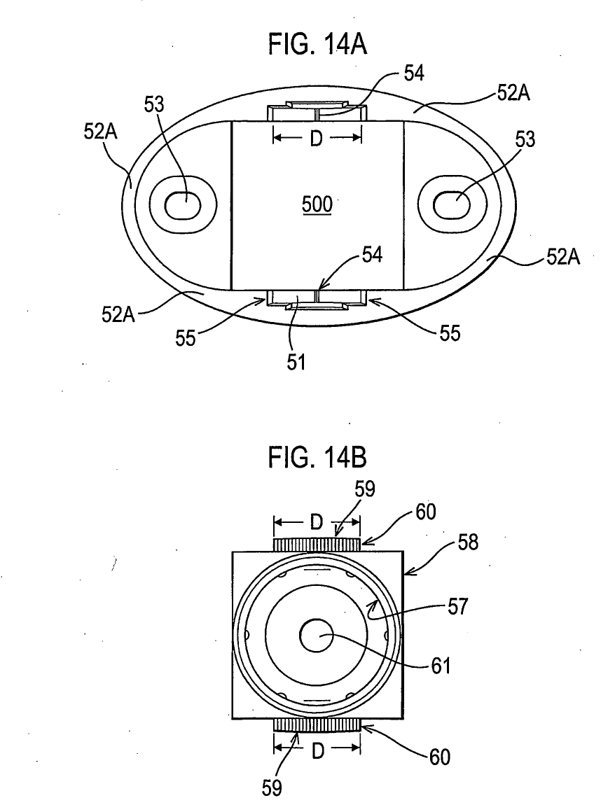

FIGS. 14A and 14B respectively illustrate a plan view of the underside of the first body portion of FIG. 11A, and a plan view of the top side of the second body portion of FIG. 11B;

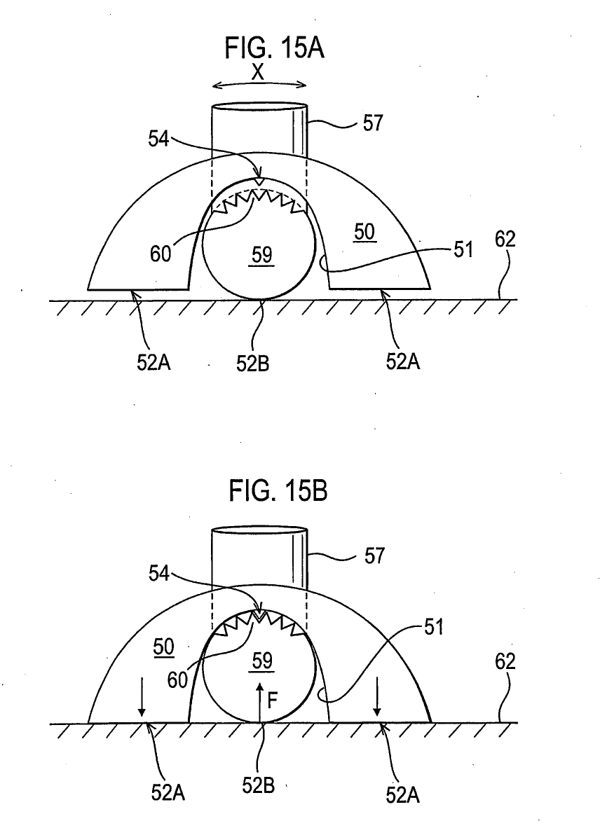

FIGS. 15A and 15B respectively schematically illustrate the abutment of the second body portion of FIG. 11B and the subsequent simultaneous abutment of both the second and first body portions of FIGS. 11A and 11B in order to bring the two portions into a locked position.

In the accompanying drawings, like items have been assigned like reference symbols for consistency.

FIG. 1 illustrates a cross-sectional view of a connector device 1 interconnecting a handrail member 2 of a stair rail assembly to a post member 3 thereof. The connector device includes a first body portion 5 abutting an outer surface portion of the hand rail member 2, and a second body portion 4 connected to the first body portion and having an attachment socket 7 within which the an end of the post member 3 is received and via which the second body portion is attached to the post member.

A pivot assembly is provided at the interface between the first and second body portions via which the second body portion is pivotably connected to the first body portion. The pivot assembly includes a collar member 10 formed as a part of the second body portion, and a corresponding axle member 8 formed as part of the first body portion and shaped to be intimately received within the collar member. The axle member 8 is a generally cylindrically shaped projection extending outwardly of a surface of the first body portion 5, the longitudinal axis of the axle member so shaped defining (and coinciding with) the axis of rotation “A” about which the second body portion 4 may be pivotably moved relative to the first body portion.

The collar member 10 presents an inwardly-facing concave annular surface which circumscribes and opposes curved convex outer surface parts of the axle member received therein. The collar member is shaped to allow it to be slid over opposing curved outer parts of the received axle member both rotationally around the axis “A” of the axle member and longitudinally along the direction of that axis. One or more lugs 9 extend from the inwardly facing annular surface of the collar member 10 and are each received in a respective guide channel 13 formed in the outer curved surface of the axle member 8. The guide channel 13 is shaped to permit respective lugs 9 to slide along it when the collar member 10 is slid around the axis “A” of the axle member when the second body portion is pivoted relative to the first body portion. The interaction of the lugs 9 with the guide channel 13 thereby serves to retain the axle member within the collar member and to guide the pivotal movement of the second body portion relative to the first body portion.

In an alternative embodiment, such as that illustrated in FIG. 9 in which like-numbered items (as between FIG. 9 and FIG. 1) are functionally equivalent, lugs 90 are formed in and extend outwardly from the convex outer surface of the axle member 80 of the pivot assembly, and corresponding guide grooves (not shown) are formed in the inwardly-facing concave annular surface of the collar member 10 for receiving and guiding the lugs 90 when the second body portion 4 pivots around the axis “A” of the axle member 80 in the first body portion 5.

The first body portion 5 (according to either embodiment) defines an outwardly presented abutment region 11 concavely shaped to reciprocally correspond with the convex shape of the outer surface of the hand rail member 2 with which it is (or is designed to be) abutted.

The connector device 1 includes locking means including a locking member 6 arranged in the first body portion within the abutment region 11 thereof. The locking member also has an outwardly presented abutment surface 12 shaped to conform to the concave shape of the abutment region 11 of the first body portion for abutment with the convex outer surface of the handrail member 2.

The locking member 6 is arranged to oppose an outwardly facing outer portion 14 of the collar member 10 and to be moveable towards that opposed outer portion, by action of the aforesaid abutment with the hand rail surface, into a locking position of engagement therewith such that pivoting movement of the second body portion relative to the first body portion is restrained by the engaged locking member 6.

In FIG. 1 the locking member 6 is placed in the locking position by action of the abutment thereof with the convex outer surface of the handrail member 2. FIGS. 10A and 10B present a view of the relevant parts of the connector member 1 looking down the axis “A” (as opposed to across it, as in FIG. 1) and schematically illustrate the process by which the locking member 6 is placed in the locking position illustrated in FIG. 1.

Referring to FIGS. 1, 10A and 10B collectively, the locking member 6 is arranged to be moveable, by action of the aforesaid abutment, from a quiescent position of outward projection from the first body portion 5 when not abutted with the hand rail surface, as illustrated in FIG. 10A, and into the locking position when so abutted as illustrated in FIG. 10B. The locking means includes a limb portion 130 of resiliently deformable material attached at one end thereof to the first body portion 5 at a location adjacent the opposed outer surface 14 of the collar member 10. The other end of the limb portion 130 is unattached to the first body portion and the locking member 6 is positioned upon the limb portion beyond the attached end thereof at or adjacent the free/unattached end thereof. The locking member is moveable relative to the first body portion by flexure of the limb portion.

The locking member 6 is biased by action of the resilience of the limb portion 130 towards the position of outward projection in which the part of the locking member 6, upon which the abutment surface 12 thereof is formed, projects outwardly of, and beyond, the abutment region 11 of the first body portion as illustrated in FIG. 10A. This quiescent (un-abutted) state enables pivoting movement (direction “X” indicated in FIG. 9, 10A) of the second body portion relative to the first body portion. The locking member 6, when in the position of outward projection, is also spaced from the opposing parts 14 of the second body portion by a substantially constant spacing which is substantially independent of movement of the second body portion relative to the first body portion. This is enabled since the second body portion presents to the locking member a convex curved opposing outer surface 14 the radius of curvature of which is substantially constant and centred upon an axis about which the second body portion is pivotably moveable relative to the first body portion. This means that the locking member moves the same distance when moving from the quiescent state into the locking position irrespective of the orientation of the first and second body portions.

The locking member is arranged to press against the second body portion in its position of engagement with the second body portion as illustrated in FIG. 10B. Movement of the first body portion 5 in the direction “Y” towards, and into abutment with, the handrail member 2 causes the outwardly projected abutment surface 12 of the locking member 6 to abut the handrail 2 before the abutment region 11 of the first body portion does so. Thus, continued movement of the un-abutted abutment region 11 towards abutment causes relative movement of the abutted locking member 6 towards the opposing surface 14 of the collar member 10 of the second body portion, and into a locking position of engagement therewith as shown in FIG. 10B.

The locking means includes a plurality of teeth arranged upon the opposed outer surface 14 of the collar member 10 and, in opposed relation thereto, two corresponding teeth 40 arranged upon the locking member 6 so as to provide a ratchet and a corresponding pawl mechanism respectively.

FIG. 2 illustrates an oblique view of one side of the second body portion 4 of the connector device illustrating the attachment socket 7, the collar member 10 of the pivot assembly and the array of ratchet teeth formed in the curved convex outer surface 14 of the collar member opposing the locking member 6 in use. The collar member 10 defines an annulus the axis of which corresponds with the pivotal axis of the pivot assembly in use. The attachment socket 7 forms an annular wall the axis of which is perpendicular to that of the collar member 10, and defines a generally cylindrically shaped socket volume within which the post member 3 is received in use. A closure wall 20 is formed across one end of the collar member 10 joining diametrically oppose parts of the peripheral circular rim at one end of the collar member.

FIG. 3 illustrates another oblique view of one end of the second body portion of the connector device illustrated in FIG. 2. Two diametrically opposed lugs 9 extend from the inwardly facing concave annular surface of the collar member, and each lug extends radially inwardly thereof. As can be seen from FIG. 3 and FIG. 4 the base of the attachment socket 7 contains a centrally disposed base aperture 16 centred upon the central axis of symmetry “B” of the annular wall defining the attachment socket 7. The attachment socket is configured relative to the collar member 10 such that the central axis of symmetry “B” thereof resides in the plane containing the circular peripheral rim of the end of the collar member nearmost the base aperture 16. Consequently, a semi circular recess 15B is formed within the near most rim of the collar member immediately adjacent the base aperture 16 such that no portion of the collar member 10 obstructs the base aperture 16. Similarly a semi circular recess 15A of similar or identical dimensions to those of the semi circular recess 15B, is formed in the same rim of the collar member 10 and is centred upon a portion of that rim and diametrically opposed to the semi circular recess 15B immediately adjacent the base aperture 16. The outwardly facing convex array of ratchet teeth 14 is centred upon the portion of the outer surface of the collar member 10 diametrically opposite the location of the base aperture 16.

Semi circular recesses 15A and 15B mutually align with the base aperture 16 to allow the insertion and fixture of a fixing means (such as a nail or a screw) into the base aperture 16 via which the post member 3 may be firmly fixed to the second body portion 4 within the attachment socket 7 thereof.

FIG. 5 illustrates a plan view of one side of the second body portion obliquely viewed in FIG. 2. The closure wall 20 of the collar member 10 is presented upper most and reveals through the openings 17 therein the pair of diametrically opposed lugs 9 extending inwardly of the inner concave annular surface of the collar member 10. One of the lugs of the pair is positioned on the collar member closer to the ratchet teeth 14 than is the other diametrically opposed lug 9 of the pair of lugs. Consequently when the ratchet teeth 14 of the curved convex outer surface of the collar member are in opposed relation to the corresponding teeth 40 of the ratchet pawl upon the locking member 6, neither of the pair of diametrically opposed lugs 9 is aligned with a respective access slot 25 (see FIGS. 6 and 7) of the axle member 8 of the first body portion 5 of the connector device. This arrangement of the lugs 9 ensures that in use, when ratchet and pawl oppose each other, the second body portion 4 is unable to disengage from the first body portion 5 since to do so would require alignment of each lug 9 with a respective access slot 25. This is a safety measure.

FIGS. 6, 7 and 8 show an oblique, side and plan view, respectively, of the first body portion 5 of the connector device. The guide channel 13 circumscribes the outer convex surface of the generally cylindrical axle member 8, and each one of a pair of access slots 25 extends from the access slot 13 along the outer cylindrical surface of the axle member in the direction of the axis thereof to the outer most end of the axle member. Each one of the pair of access slots 25 opposes the other slot of the pair diametrically across the axis of the axle member 8, the pair of slots being equidistant from the locking member 6.

Apertures 27 are arranged within the first body portion 11 either side of the axle member 8 thereof and pass from the upper surface of the first body portion through to the abutment region 11. The apertures 27 are arranged to receive and house fixing screws 26 via which the first body portion 5 may be fixedly pressed against the hand rail 2 in a state of abutment therewith in use.

As an alternative to the use of screws 26 as fixing means for the first body portion, nails or adhesives may be employed additionally or alternatively. FIG. 7 illustrates the outwardly presented abutment surface 12 of the locking member 6 in a position of outward projection from the concave abutment region 11 of the first body portion 5. The outwardly presented abutment surface 12 of the locking member conforms to the shape of the abutment region which in turn is shaped to reciprocally correspond with the convex shape of the surface of the hand rail 2 with which it is arranged to abut in use.

FIGS. 11A to FIG. 15B illustrate another embodiment of the present invention. In these figures like items are assigned like reference symbols for clarity and consistency.

FIG. 11A and FIG. 11B respectively illustrate oblique views of first and second body portions of a connector device. The first body portion 50 of this connector device defines a structure possessing an underside defining an abutment surface 52A shaped and dimensioned for abutment with a surface of a member, such as a stair rail member (not shown), to which the first body portion is designed to be connected in use. Apertures 53 are formed in the structure of the first body portion for the purposes of accepting screws or nails, or the like, via which the first body portion may be firmly secured to the surface of a member when abutted thereto. Other means of securing the first body portion to a surface may be employed, such as adhesives, and apertures 53 for screws or nails may be dispensed with in that case.

The abutment surface 52A of the first body portion 50 is defined by the outwardly-presented terminal underside edge of an enclosing wall structure 400 which extends in a direction generally transverse to the plane of the abutment surface 52A. The enclosing wall structure 400 defines an opening 500 dimensioned to receive and house parts of the second body portion 56 illustrated in FIG. 11B.

Opposing inwardly-presented surfaces of the enclosing wall structure 400 of the first body portion 50 each defines one of two collar structures 51 substantially equal in structure and dimension and each being formed at one inwardly-presented surface such that any given part of one such collar structure directly and symmetrically opposes the corresponding or equivalent part of the opposing collar structure of the pair formed in an opposing part of the wall structure 400 of the first body portion.

FIG. 12A illustrates a cross-sectional view of the first body portion of FIG. 11A across the axis of symmetry of the first body portion across which each collar 51 of the pair of collars oppose the other. The illustration of FIG. 12A shows the inwardly-presented surface of one side of the enclosing wall structure 400, the other side of that enclosing structure being substantially identical. The collar 51 is defined by a channel formed in the inwardly-presented enclosing wall surface. The channel extends across the inwardly-presented surface from an opening 55 formed at the inner edge of the abutment surface 52A of the first body portion. This channel then extends along the inwardly-presented surface of the enclosing wall structure 400 in a direction generally transverse to that of the abutment surface 52A terminating at a semi-circular channel wall outwardly from which (and inwardly of the channel) projects a tooth 54 defining a locking member of the connector device.

In this way, the collar 51 is provided by the walls of a channel extending from the abutment surface of the first body portion, along the inwardly-presented surface of the enclosing wall structure 400 of the first body portion, and terminating with a semi-circular concave channel wall from which a locking member projects into the channel. FIG. 14A illustrates the underside of the first body portion 50 showing the abutment surface 52A, the opening 55 of the channel formed within the abutment surface, and the tooth 54 defining the locking member and projecting inwardly to the channel from the channel wall at its terminal end.

FIG. 11B illustrates an oblique view of the second body portion 56 of the connector device. The second body portion includes a socket 57 arranged to receive a post-like member of a handrail assembly (e.g. dowelling, not shown), and an axle member 58 extending along an axle axis generally transverse to the axis along which the socket 57 extends. The axle member 58 presents a generally cylindrical outer surface from a part of which transversely extends the socket 57, and from a generally diametrically opposed part of which is provided an aperture 61 dimensioned to receive a locking screw or nail for the purposes of securing the hand rail member (not shown) within the socket 57 to the second body portion in use. The outer curved cylindrical surface of the axle member 58 adjacent and surrounding the aperture 61 forms an abutment surface 52B arranged for abutment with the surface of the member against which the abutment surface 52A of the first body portion is arranged to be abutted in use. Cylindrical disk-like bearing members 59 are formed in, and project from, the surface of the axle member 58 and are arranged to be circularly symmetrically centred upon the cylindrical axis of the axle member 58 each having a cylindrical diameter D which is less than the cylindrical diameter of the greater cylindrical body of the axle member 58. A cylindrical bearing member 59 is arranged at each flat terminal cylindrical end of the greater cylindrical body of the axle member. FIGS. 12B and 13B show side and cross-sectional views of the second body portion illustrating in more detail the features described with reference to FIG. 11B above. Each of the two cylindrical bearing members 59 forms one of a pair of axle bearings having cylindrical axis of symmetry aligned with each other and mutually aligned with the cylindrical symmetry of axis of the axle member 58 from which each bearing member 59 outwardly protrudes.

The outwardly protrusion of each of the pair of cylindrical bearing members 59 defines an outwardly-presented curved cylindrical bearing surface continuously across one half of which is formed an array of teeth 60. These teeth are arrayed to point in a direction generally away from the position of the abutment surface 52B of the second body portion and generally towards the direction of the socket 57 thereof. The top view of the second body portion illustrated in FIG. 14B shows this arrangement clearly.

The cylindrical diameter D of each of the cylindrical bearing members 59 is dimensioned to be wholly receivable within any respective one of each of the opposed collars 51 formed within the inwardly-presented surface of the enclosing wall structure 400 of the first body portion 50. In this example, the radius of curvature of the semi-circular terminal end of the channel defining each collar 51 of the first body portion is substantially equal to one half of the diameter D of the cylindrical bearing members 59.

The second body portion is arranged and dimensioned to be inserted, socket 57 first, through the opening 500 defined by the enclosing wall structure 400 of the first body portion, such that each one of the aligned pair of bearing members 59 of the second body portion is received by the collar opening 55 of a respective one of the pair of opposed and aligned collars 51 of the first body portion 50. By pushing the second body portion further into the opening 500 of the first body portion, the pair of cylindrical bearing members 59 are progressively pushed along the channels of the collars 51 within which they are received until such time as the semi-circular terminal wall of the collar channel is reached by the tooth-bearing curved cylindrical surface of a received cylindrical bearing member. At this point each cylindrical bearing member 59 is substantially intimately seated within an enclosing semi-circular collar wall preventing further forward motion along the respective channel. In this way the second body portion becomes connected to or attached to the first body portion, and both the first and second body portions may subsequently be simultaneously abutted to a common surface 62 of a stair rail member (or the like) in use as is simply schematically illustrated in FIGS. 15A and 15B. Referring to FIG. 15A, a cylindrical bearing member 59 is received within the collar 51 of the first body portion 50. The abutment surface 52B of the axle member 58 of the second body portion is abutted to the surface 62 of the stair rail member, while the abutment surface 52A of the first body portion is not so abutted. In this condition, the engagement member, 54, formed as a tooth in the first body portion is in the position to engage with at least the upper parts of opposing teeth 60 formed in the outer cylindrical surface of the cylindrical bearing member 59. Subsequent abutment of the first body portion against the surface 62 of the stair rail member is illustrated in FIG. 15B and results in tooth 54 being moved into an active engagement between neighbouring opposing teeth of the cylindrical bearing member 59 within the collar 51 of the first body portion. In this way the tooth 54 is pressed against the bearing member of the second body portion by action of the abutment of the first body portion with the surface of the stair rail member 62 thereby to secure the first and second body portions in the locked position. Prior to this final abutment, the second body portion though seated within the collar 51 of the first body portion is substantially free to move pivotally relative to the first body portion as indicated by arrow X of FIG. 15A thereby enabling a user to appropriately position/orient the second body portion relative to the surface 62 of the stair rail member in use such that subsequent abutment of the first body portion again the stair rail member surface will secure the second body portion in the chosen position/orientation.

The dimensions of the axle member 58 of the second body portion is chosen such that when the locking member of the first body portion engages the second body portion with the first body portion abutted with the surface 62 of the stair rail member, the abutment surface 52B of the second body portion is simultaneously abutted to the stair rail member surface 62. This ensures the application of a reactive force F (illustrated in FIG. 15B) to the second body portion from the abutted surface 62 of the stair rail member, which urges the teeth 60 of the cylindrical bearing member 59 into engagement with the tooth 54 of the first body portion 51. This reactive force F may press the teeth 60 against the tooth 54 in which case the abutment surface 52B of the second body portion is arranged to be flush with the plane containing the abutment surface 52A of the first body portion when the tooth 54 of the first body portion is fully engaged with (and in contact with) a notch defined by neighbouring teeth 60 of a cylindrical bearing member 59, this being so prior to mutual abutment of the first and second body portions with the surface 62 of the stair rail member such that subsequent such simultaneous abutment merely secures the tooth 54 in the aforementioned position. Alternatively, the axle member may be dimensional such that the abutment surface 52B of the second body portion very slightly projects or protrudes outwardly beyond the plane containing the abutment surface 52A of the first body portion when the tooth 54 is in the aforementioned position, such that subsequent mutual abutment of the first and second body portions with the common surface 52 of the stair rail member further forces the tooth 54 of the first body portion against and into the notch between neighbouring teeth of the aforementioned bearing member 59. The first and/or the second body portions may be made of resiliently deformable material in this case to permit the slight protrusion (e.g. a fraction of a millimetre) of the abutment surface 52B of the second body portion to be pushed (by deformation) fully into the receiving opening 55 of the abutment surface 52A of the first body portion thereby permitting the latter abutment surface to abut the stair rail member in use.

While the above embodiments provide examples of the present invention, it is to be understood that variants and modifications may be made to these embodiments, such as would be readily apparent to the person skilled in the art, without department from the scope of the present invention.

1-26. (canceled)

27. A connector device for interconnecting two members, the device including a first body portion arranged for abutment with a surface of one of the two members, a second body portion moveably attached to the first body portion and having attachment apparatus for attachment thereof to the other of the two members, and locking apparatus including a locking member arranged to be secured, by action of said abutment with said surface, into a locking position of engagement with the second body portion such that movement of the second body portion relative to the first body portion is restrained by the engaged locking member.

28. A connector device according to claim 27 in which the locking apparatus is arranged in the first body portion to move, by action of said abutment with said surface, into a locking position of engagement with the second body portion.

29. A connector device according to claim 27 in which a part of the second body portion is secured between the first body portion and said surface by action of said abutment thereby to secure said locking apparatus into a locking position.

30. A connector device according to claim 27 in which the locking apparatus is a part of the first body portion arranged to be secured against an opposing part of the second body portion in said locking position by action of abutment of said first body portion with said surface.

31. A connector device according to claim 27 in which the second body portion is arranged to abut said surface by action of the abutment of the first body portion with said surface thereby to permit simultaneous abutment of said first and said second body portions with said surface.

32. A connector device according to claim 27 wherein a part of the second body portion is arranged to abut said surface, and to be moveable from a position of outward protrusion beyond the first body portion when the first body portion is not abutted with said surface, to a position of flush adjacency with abutting parts of the first body portion by action of the abutment of the first body portion with said surface.

33. A connector device according to claim 27 wherein the locking apparatus is arranged for abutment with said surface and to be moveable by action of that abutment from a position of outward projection from the first body portion when not abutted with said surface, to said locking position when so abutted.

34. A connector device according to claim 27 including a pivot via which the second body portion is moveably connected to the first body portion so as to be pivotably moveable relative thereto.

35. A connector device according to claim 27 in which the locking apparatus is arranged to press against the second body portion in its position of engagement with the second body portion.

36. A connector device according to claim 27 in which the locking apparatus includes one or more teeth via which the locking apparatus and the second body portion engage each other when in said position of engagement.

37. A connector device according to claim 36 wherein the locking apparatus includes one or more teeth arranged upon the second body portion and, in opposed relation thereto, one or more corresponding teeth arranged upon the locking member so as to provide a ratchet and a corresponding pawl respectively.

38. A connector device according to claim 33 in which the locking apparatus is biased towards said position of outward projection from the first body portion.

39. A connector device according to claim 38 in which the locking apparatus includes a limb portion of resiliently deformable material one end of which is attached to the first body portion and the other end of which is unattached thereto wherein the locking apparatus is positioned upon the limb portion beyond the one end thereof at or adjacent the other end thereof and is moveable relative to the first body portion by flexure of the limb portion.

40. A connector device according to claim 27 wherein the first body portion defines an outwardly presented abutment region shaped to reciprocally correspond with the shape of said surface with which it is arranged to be abutted, and the second body portion has an outwardly presented abutment surface shaped to conform to the shape of the abutment region.

41. A connector device according to claim 33 in which the locking apparatus when in said position of outward projection is spaced from the opposing parts of the second body portion by a substantially constant spacing which is substantially independent of movement of the second body portion relative to the first body portion.

42. A connector device according to claim 27 in which the second body portion presents to the locking member a curved outer surface the radius of curvature of which is substantially constant and centred upon an axis about which the second body portion is pivotably moveable relative to the first body portion.

43. A connector device according to claim 34 wherein the pivot includes a collar member of the first body portion and a corresponding axle member of the second body portion and shaped to be intimately received within the collar member.

44. A connector device according to claim 27 wherein said locking apparatus interfaces with said second body portion to offer resistance to movement of the second body portion relative to the first body portion when the first body part is not abutted with said surface thereby to prevent free movement of the second body portion relative to the first without locking the two body portions.

45. A connector device according to claim 27 including fixing apparatus for fixing the first body portion in abutment with said surface such that said surface presses against the locking apparatus thereby to press the locking apparatus into said locking position.

46. A connector device according to claim 27 interconnecting the two members wherein the two members comprise members of a stair rail assembly.

47. A connector device according to claim 43 interconnecting the two members wherein the two members comprise members of a stair rail assembly.

48. A stair rail assembly according to claim 43 or claim 44 including said connector device and said two members.

49. A kit of parts for a providing, when assembled, a connector device according to any of preceding claims 27 to 42.

50. A kit of parts for a providing, when assembled, a stair rail assembly according to claim 45.

51. A kit of parts for a connector device for interconnecting two members, the parts including a first body portion arranged for abutment with a surface of one of the two members, a second body portion arranged to be moveably attached to the first body portion and having attachment apparatus for attachment thereof to the other of the two members, and locking apparatus including a locking member arranged in the first body portion to be secured, by action of said abutment with said surface, into a locking position of engagement with the second body portion of the assembled device such that movement of the second body portion relative to the first body portion is restrained by the engaged locking apparatus.

52. A kit of parts according to claim 48 in which the locking apparatus is arranged in the first body portion to move, by action of said abutment with said surface, into a locking position of engagement with the second body portion.
